(19) United States
(12) Patent Application Publication
(10) Pub. No.: US 2012/0206194 A1
(43) Pub. Date: Aug. 16, 2012

(54) POLARITY SWITCH CIRCUIT FOR CHARGER

(75) Inventors: KUO-CHIANG CHEN, NEW TAIPEI CITY (TW); YEN-YI CHEN, NEW TAIPEI CITY (TW)

(73) Assignee: FORTUNE SEMICONDUCTOR CORPORATION, NEW TAIPEI CITY (TW)

(21) Appl. No.: 13/028,330

(22) Filed: Feb. 16, 2011

(51) Int. Cl. G05F 1/10

(52) U.S. Cl. 327/543

(57) ABSTRACT

A polarity switch circuit for a charger is disclosed. The circuit includes a polarity switch unit and an input control unit. The polarity switch unit includes an input end, an output end, a correct-direction connecting circuit, and a reverse-direction connecting circuit. The correct-direction connecting circuit has a first switch unit and a second switch unit. When the load is plugged correctly, the positive input node is connected to the positive output node by the first switch unit, and the negative input node is connected to the negative output node by the second switch unit. The reverse-direction connecting circuit includes a third switch unit and a fourth switch unit. When the load is plugged reversely, the positive input node is connected to the negative output node by the third switch unit, and the negative input node is connected to the positive output node by the fourth switch unit.

### BACKGROUND OF THE INVENTION

1. Field of the Invention

The present disclosure relates to a polarity switch circuit, especially to a polarity switch circuit for a charger, which prevents any circuit damage due to incorrect plugging of a rechargeable battery by the user.

2. Description of Related Art

The type of electronic devices and application chips has been increased, in which many electronic devices and nodes of chips have their predetermined polarity or sequence for various applications.

Generally, the electronic devices or application chips will define the sequence and polarities of their nodes which are not allowed to be wrongly connected. The wrongly connected electronic devices and application chips may be unworkable or even damaged, thus reducing stability and safety of the whole circuit.

For example, when a rechargeable battery is plugged to a charger in a manner which the positive and negative polarities of the rechargeable battery are connected correctly, the charger can charge the rechargeable battery normally. But when the user unintentionally plugs the rechargeable battery a polarity-reversely, the charger may not correctly charge the rechargeable battery, and may be damaged by the feedback current and voltage generated by the remaining power in the rechargeable battery. The circuit of charger may be broken down and cause current leakage, thus reducing the stability and the safety when using the charger.

### SUMMARY OF THE INVENTION

The present disclosure is associated with a polarity switch circuit for a charger. The polarity switch circuit may still works normally when the user wrongly plugs a load (such as a rechargeable battery) to the charger. Therefore, the practical value of the charger may be increased.

According to an exemplary embodiment of the present disclosure, a polarity switch circuit is described. The polarity switch circuit includes a polarity switch unit and an input control unit. In which the polarity switch unit includes an input end, an output end, a correct-direction connecting circuit, and a reverse-direction connecting circuit.

The polarity switch unit is used to receive an input power for charging a load. A connection polarity of the load which connects to the polarity switch unit is detected, for determining an output polarity of an output power provided to the load. The input end of the polarity switch unit has a positive input node and a negative input node for receiving an input power. The output end of the polarity switch unit has a positive output node and a negative output node for outputting the output power to the load. The correct-direction connecting circuit and the reverse-direction connecting circuit are electrically connected between the input end and the output end. When a voltage of the load connected at the positive output node is greater than a voltage of the load connected at the negative output node, the correct-direction connecting circuit connects the positive input node to the positive output node and the negative input node to the negative output node. Otherwise, when the voltage of the load connected at the positive output node is smaller than the voltage of the load connected at the negative output node, the reverse-direction connecting circuit connects the positive input node to the negative output node and the negative input node the positive output node.

The correct-direction connecting circuit includes a first switch unit and a second switch unit. The first switch unit is electrically connected between the positive input node and the positive output node. A first control end of the first switch unit is electrically connected to the negative output node. The second switch unit is electrically connected between the negative input node and the negative output node. A second control end of the second switch unit is electrically connected to the positive output node.

The reverse-direction connecting circuit includes a third switch unit and a fourth switch unit. The third switch unit is electrically connected between the positive input node and the negative output node. A third control end of the third switch unit is connected to the positive output node. The fourth switch unit is electrically connected between the negative input node and the positive output node. A fourth control end of the fourth switch unit is electrically connected to the negative output node.

The first switch unit and the second switch unit are turned on when the voltage of the load connected at the positive output node is greater than the voltage of the load connected at the negative output node. The third switch unit and the fourth switch unit are turned on when the voltage of the load connected at the negative output node is greater than the voltage of the load connected at the positive output node.

Additionally, the input control unit is electrically connected to the polarity switch unit for providing the input power to the polarity switch unit. The input control unit retrieves a load voltage of the load and adjusts the voltage and current of the input power according to the load voltage. The input control unit includes a voltage feedback unit and a voltage and current generating unit. The voltage feedback unit is electrically connected to the output end for feeding back a load voltage of the load. The voltage and current generating unit is electrically connected the voltage feedback unit to the input end. The voltage and current generating unit includes a positive feedback end and a negative feedback end, for receiving the load voltage fed back by the voltage feedback unit, and for controlling the voltage and current of input power received by the input end according to the load voltage. Therefore, the load voltage may be charged to a predetermined voltage value and won't be affected by additional power consumption taken by the polarity switch unit.

The voltage feedback unit includes a first feedback switch, a second feedback switch, a third feedback switch, and a fourth feedback switch. The first feedback switch and the second feedback switch are turned on when the voltage of the load connected at the positive output node is greater than the voltage of the load connected at the negative output node. The third feedback switch and the fourth feedback switch are turned on when the voltage of the load connected at the negative output node is greater than the voltage of the load connected at the positive output node.

In an exemplary embodiment, the first switch unit, the third switch unit, the first feedback switch, and the third feedback switch are P-type metal-oxide-semiconductor field-effect transistors (MOSFETs). The second switch unit, the fourth switch unit, the second feedback switch, and the fourth feedback switch are N-type MOSFETs. Moreover, the width to length ratios of the first switch units, the second switch unit, the third switch unit, and the fourth switch unit are greater than the width to length ratios of the first feedback switch, the second feedback switch, the third feedback switch, and the fourth feedback switch.

By providing the polarity switch circuit to the charger, the charger may work normally even when the polarity of the load is plugged in a reverse manner. Therefore, current leakages which occurs when the remaining power of the load is unexpectedly fed back to the charger may be avoided according to the present disclosure. Thereby, the practical value and safety when using the charger can be increased.

For further understanding of the present disclosure, reference is made to the following detailed description illustrating the embodiments and examples of the present disclosure. The description is only for illustrating the invention, not for limiting the scope of the claim.

### BRIEF DESCRIPTION OF THE DRAWINGS

The drawings included herein provide further understanding of the present disclosure. A brief introduction of the drawings is as follows:

FIG. 1 is a block diagram of a polarity switch unit according to an exemplary embodiment of the present disclosure;

FIG. 2A is a schematic view of circuit of a polarity switch unit according to an exemplary embodiment of the present disclosure;

FIG. 2B is a schematic view of circuit of a polarity switch unit according to another exemplary embodiment of the present disclosure;

FIG. 3A is a schematic view of operation of a polarity switch unit when a load is correctly plugged according to an exemplary embodiment of the present disclosure;

FIG. 3B is a schematic view of operation of a polarity switch unit when a load is reversely plugged according to an exemplary embodiment of the present disclosure;

FIG. 4 is a block diagram of a polarity switch circuit for a charger according to an exemplary embodiment of the present disclosure;

FIG. 5A is a schematic view of circuit of a polarity switch circuit for a charger according to an exemplary embodiment of the present disclosure;

FIG. 5B is a schematic view of circuit of a polarity switch circuit for a charger according to another exemplary embodiment of the present disclosure;

FIG. 6A is a schematic view of operation of a polarity switch circuit for a charger when a load is correctly plugged according to an exemplary embodiment of the present disclosure: and

FIG. 6B is a schematic view of operation of a polarity switch circuit for a charger when a load is reversely plugged according to an exemplary embodiment of the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended tables.

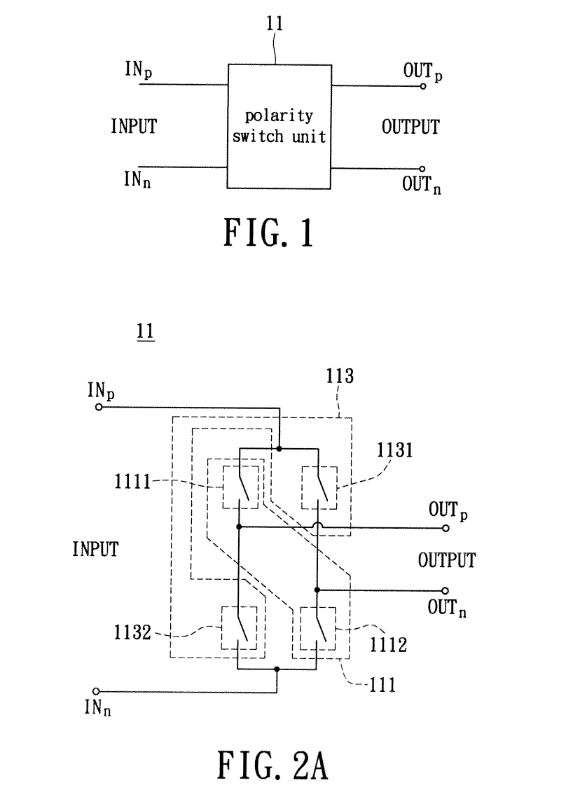

Referring to FIG. 1, a polarity switch unit 11 in a charger may be used to switch an output polarity of an output power. When a load (not shown, such as a rechargeable battery) is plugged to a positive output node OUTp and a negative output node OUTn of an output end OUTPUT, the polarity switch unit 11 detects whether a connection polarity to which the load is connected is correct or not. In other words, the polarity switch unit 11 detects whether the high-voltage end of the load is connected to the positive output node OUTp and the low-voltage end of the load is connected to the negative output node OUTn, and determines the output polarity of the output power which is provided to the load according to the detected results.

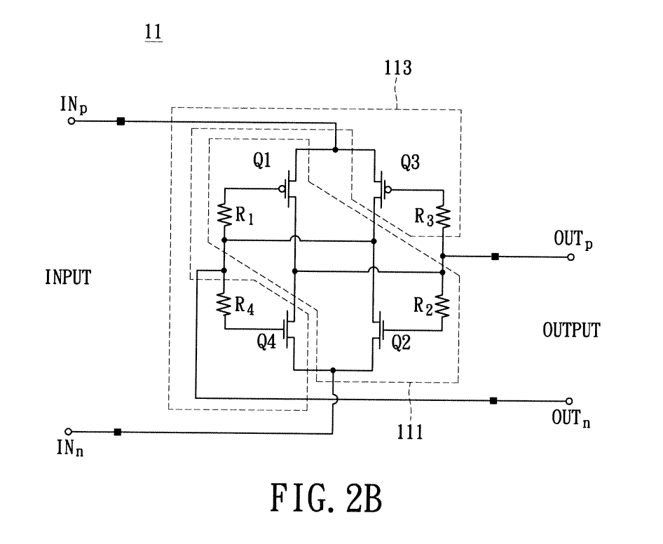

Please refer to FIG. 2A. FIG. 2A is a schematic view of circuit of a polarity switch unit 11 according to one exemplary embodiment of the present disclosure. The polarity switch unit 11 includes an input end INPUT, an output end OUTPUT, a correct-direction connecting circuit 111, and a reverse-direction connecting circuit 113. The input end INPUT includes a positive input node INp and a negative input node INn for receiving an input power. The output end OUTPUT includes a positive output node OUTp and a negative output node OUTn for connecting with a load such as a rechargeable battery. The correct-direction connecting circuit 111 includes a first switch unit 1111 and a second switch unit 1112. The reverse-direction connecting circuit 113 includes a third switch unit 1131 and a fourth switch unit 1132.

The first switch unit 1111 is connected between the positive input node INp and the positive output node OUTp. The second switch unit 1112 is connected between the negative input node INn and the negative output node OUTn. The third switch unit 1131 is connected between the positive input node INp and the negative output node OUTn. The fourth switch unit 1132 is connected between the negative input node INn and the positive output node OUTp.

In this exemplary embodiment, the operation manners of the first switch unit 1111, the second switch unit 1112, the third switch unit 1131, and the fourth switch unit 1132 are described as follows. When the connection polarity of the load (such as a rechargeable battery) to which the output end OUTPUT is connected is in correct direction, i.e., the high-voltage end of the load is connected to the positive output node OUTp and the low-voltage end of the load is connected to the negative output node OUTn, the first switch unit 1111 and the second switch unit 1112 are turned on while the other switch units are turned off. In this situation, the positive input node INp is electrically connected to the positive output node OUTp and the negative input node INn is electrically connected to the negative output node OUTn. Otherwise, when the connection polarity of the load to which the output end OUTPUT is connected is in a reverse direction, the third switch unit 1131 and the fourth switch unit 1132 are turned on while the other two switch units are turned off. In the second situation, the positive input node INp is electrically connected to the negative output node OUTn and the negative input node INn is electrically connected to the positive output node OUTp.

Therefore, no matter the load is connected to the output end OUTPUT correctly or reversely, the charger may work normally in both situations for charging the load. In addition, the first switch unit 1111, the second switch unit 1112, the third switch unit 1131, and the fourth switch unit 1132 may be any kind of switch such as relay or transistor.

Please refer to FIG. 2B. FIG. 2B is a schematic view of a polarity switch unit 11 according to another exemplary embodiment of the present disclosure. The exemplary embodiment shown in FIG. 2B is the same as that in FIG. 2A, except that the first switch unit 1111 and the third switch unit 1131 in FIG. 2B are P-type metal oxide semiconductor field effect transistors (MOSFETs) Q1 and Q3 respectively, and the second switch unit 1112 and the fourth switch unit 1132 are N-type MOSFETs Q2 and Q4 respectively.

As shown in FIG. 2B, a first control end (the gate of the MOSFET Q1) of the first switch unit 1111 is connected to the negative output node OUTn, and a second control end (gate of the MOSFET Q2) of the second switch unit 1112 is connected to the positive output node OUTp. Therefore, when the voltage of the load connected at the positive output node OUTp exceeds the voltage of the load connected at the negative output node OUTn to an amount reaching the threshold voltage of MOSFET, the first switch unit 111 1 may be turned on for electrically connecting the positive input node INp to the positive output node OUTp. Similarly, the second switch unit 1112 may also be turned on for electrically connecting the negative input node INn to the negative output node OUTn, in order to form a loop path for power transmission.

On the other hand, the third control end (gate of the MOSFET Q3) of the third switch unit 1131 of the reverse-direction connecting circuit 113 is connected to the positive output node OUTp, and the fourth control end (gate of the MOSFET Q4) of the fourth switch unit 1132 is connected to the negative output node OUTn. Opposite to the correct-direction connecting circuit 111, the third switch unit 1131 of the reverse-direction connecting circuit 113 is turned on when the voltage of the load connected at the negative output node OUTn is greater than the voltage of the load connected at the positive output node OUTp for an amount reaching the threshold voltage of MOSFET. Thus, in this situation, the third switch unit 1131 is turned on for electrically connecting the positive input node INp to the negative output node OUTn. Similarly, the fourth switch unit 1132 is turned on for electrically connecting the negative input node INn to the positive output node OUTp.

In other words, with the mentioned control operation of the MOSFETs Q1, Q2, Q3, and Q4, the positive input node INp may be electrically connected to the output node with higher voltage, while the negative input node INn may be connected to the output node having lower voltage. Therefore, the charging circuit may work normally.

Furthermore, a first buffer resistor R1 is provided and connected between the gate of the first MOSFET Q1 and the negative output node OUTn, for buffering any signals transmitted from the negative output node OUTn to the gate of the first MOSFET Q1, in order to prevent undue voltage or current from causing any damage to the MOSFET Q1. Similarly, a second buffer resistor R2 is connected between the gate of the second MOSFET Q2 and the positive output node OUTp. A third buffer resistor R3 is connected between the gate of the third MOSFET Q3 and the positive output node OUTp. A fourth buffer resistor R4 is connected between the gate of the MOSFET Q4 and the negative output node OUTn.

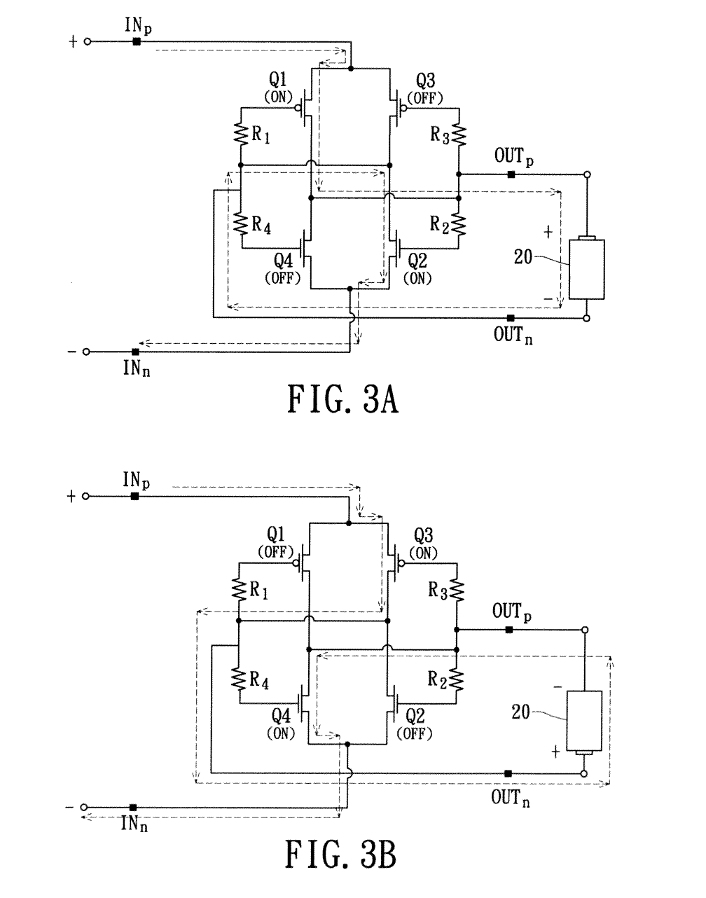

Please refer to FIG. 3A which is a schematic view of operation of the circuit in FIG. 2B. As shown in FIG. 2B, the connection polarity of the load 20 which is plugged by the user is connected correctly, i.e., the positive end (high voltage end) of the load 20 is connected to the positive output node OUTp and the negative end (low voltage end) of the load 20 is connected to the negative output node OUTn. In this case, the first MOSFET Q1 and the second MOSFET Q2 of the correct-direction connecting circuit 111 are turned on, while the third MOSFET Q3 and the fourth MOSFET Q4 of the reverse-direction connecting circuit 113 are turned off.

Therefore, in FIG. 3A, the positive input node INp may be electrically connected to the positive output node OUTp because the first MOSFET Q1 is closed, and the negative input node INn may be electrically connected to the negative output node OUTn because the second MOSFET Q2 is closed. The polarity of the input power received by the input end INPUT is fixed, i.e., the positive input node INp has higher voltage related to the negative input node INn. Therefore, the flowing path of the current is from the positive input node INn to the positive output node OUTp through the first MOSFET Q1, for charging the load 20. After charging, the current flows from the negative end of the load 20 back to the negative input node INn through the second MOSFET Q2, which forms a power transmission loop path.

On the other hand, please refer to FIG. 3B which is a schematic view of operation of the circuit in FIG. 2B according to another exemplary embodiment of the present disclosure. In this exemplary embodiment, the load 20 is plugged reversely, i.e., the positive end (high voltage) of the load 20 is connected to the negative output node OUTn while the negative end (low voltage) of the load 20 is connected to the positive output node OUTp. In this case, the first MOSFET Q1 and the second MOSFET Q2 are turned off while the third MOSFET Q3 and the fourth MOSFET Q4 are turned on.

As shown in FIG. 3B, the positive input node INp may be electrically connected to the negative output node OUTn because the MOSFET Q3 is turned on, and the negative input node INn may be electrically connected to the positive output node OUTp because the MOSFET Q4 is turned on. Therefore, the flowing path of the charging current is from the positive input node INp to the negative output node OUTn through the third MOSFET Q3, and inputting into the positive electrode of the load 20. The current then flows from the negative electrode of the load 20 back to the negative input node INn through the positive output node OUTp and the fourth MOSFET Q4, which forms the power transmission loop path.

That is, no matter the load 20 is connected to the output end OUTPUT in correct direction or in reverse direction, the positive input node INp may be electrically connected to the end of the load 20 with higher voltage level, and the negative input node INn may be electrically connected to the end of the load 20 with lower voltage end. Therefore, the input power received by the input end INPUT may normally used for charging the load 20. In addition, the residual electric power in the load 20 may not be fed back to the polarity switch circuit. Thus, no current leakage may be generated, and the use of safety and the practical value of the charger are increased.

It is worth noting that a bipolar junction transistor (BJT) is a current-drove device which generates a current flow at its base while operating. Thus, the BJT may increase power consumption and decrease charging performance while operating. Compared to BJT, a MOSFET may not generate additional current at its gate while operating. Thus, the MOSFET may not cause any additional power consumption due to unexpected current flow, which means the MOSFET has better efficiency than BJT. Therefore, in a preferred embodiment, the MOSFETs may be used to implement the switch devices in the present disclosure, for reducing power consumption and cost, and improving the total efficiency.

Furthermore, as shown in FIG. 3A and FIG. 3B, no matter the load 20 is plugged correctly or reversely, the charging loop may pass two switch units, one is P-type MOSFET and the other is N-type MOSFET. Both the N-type MOSFET or P-type MOSFET have their inner resistances which makes the voltage difference between the positive output node OUTp and the negative output node OUTn slightly smaller than the voltage difference between the positive input node INp and the negative input node Inn, due to the consumption of electric power when the current flow passes through the two switches. That is, the additional power consumption of the polarity switch unit 11 makes the charging result inaccurate.

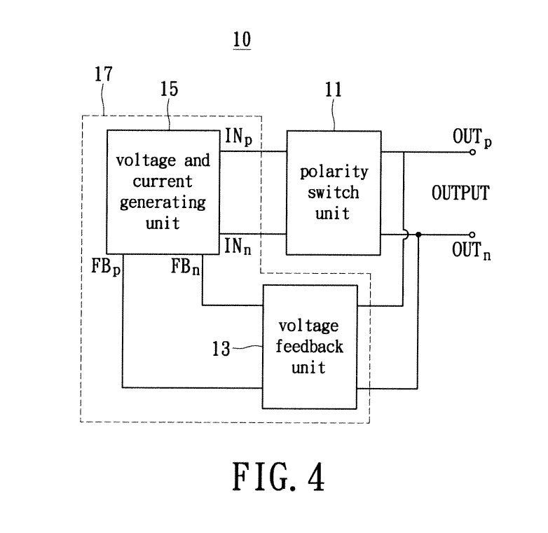

Please refer to FIG. 4 which is a block diagram of a polarity switch circuit 10 for charger according to one exemplary embodiment of the present disclosure. The polarity switch circuit 10 includes a polarity switch unit 11 and an input control unit 17. The input control unit 17 includes a voltage feedback unit 13 and a voltage and current generating unit 15. The voltage feedback unit 13 is electrically connected to the output end OUTPUT and the voltage and current generating unit 15, for feeding back a load voltage of the load connected to the output end OUTPUT. Thereby, the voltage and current generating unit 15 may adjust the voltage difference and current of the input power received by the positive input node INp and the negative input node INn, for charging the load. Thus, the load voltage of the load may reach a predetermined voltage value accurately and may not be influenced by any additional power consumption caused by the polarity switch unit 11.

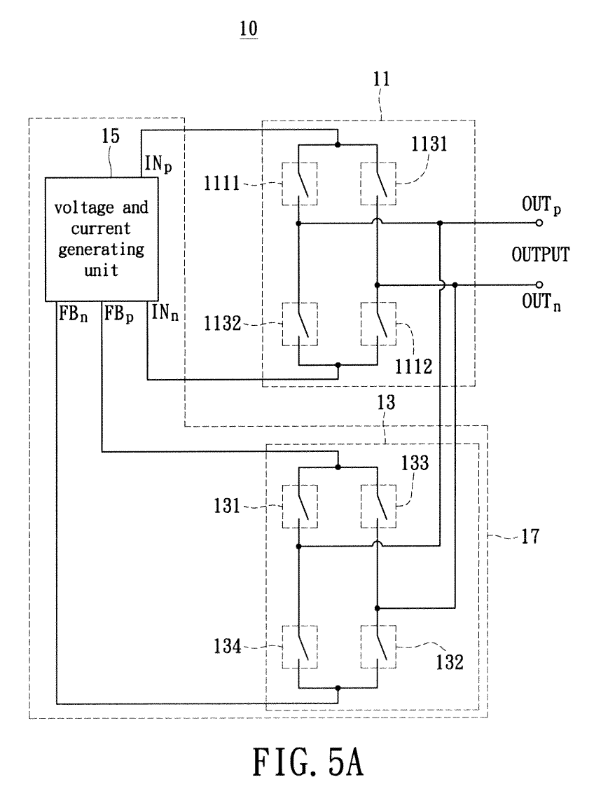

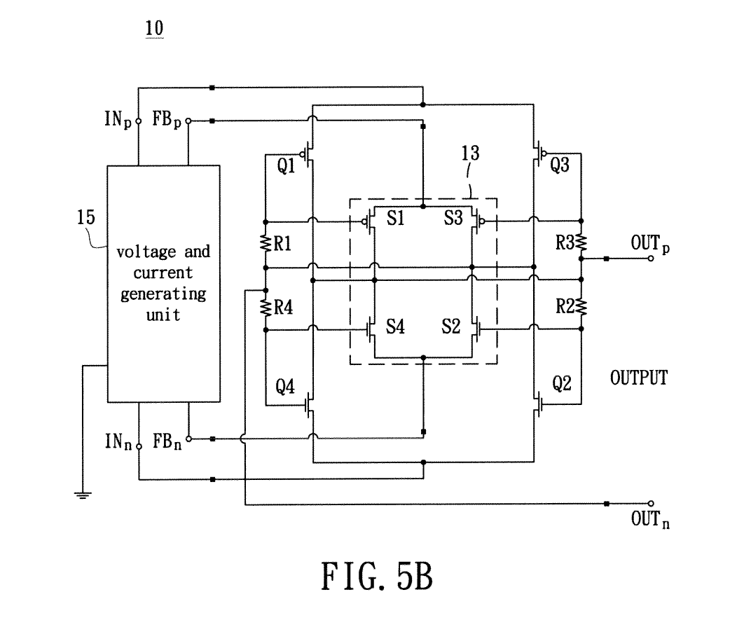

Please refer to FIG. 5A which is a schematic view of a polarity switch circuit 10 for a charger according to one exemplary embodiment of the present disclosure. The exemplary embodiment in FIG. 5A is the same as in FIG. 2A, except that FIG. 5A additionally includes an input control unit 17 which has a voltage feedback unit 13 and a voltage and current generating unit 15. The voltage feedback unit 13 is electrically connected to the output end OUTPUT for feeding the load voltage of the load (rechargeable battery) connected to the output end OUTPUT back to the voltage and current generating unit 15. The voltage and current generating unit 15 receives the load voltage by a positive feedback end FBp and a negative feedback end FBn, and adjusts the voltage and current transmitted to the input end INPUT according to the load voltage.

The voltage feedback unit 13 includes a first feedback switch 131, a second feedback switch 132, a third feedback switch 133, and a fourth feedback switch 134. The first feedback switch 131 is connected between the positive output node OUTp and the positive feedback end FBp. The second feedback switch 132 is connected between the negative output node OUTn and the negative feedback end FBn. The third feedback switch 133 is connected between the negative output node OUTn and the positive feedback end FBp. The fourth feedback switch 134 is connected between the positive output node OUTp and the negative feedback end FBn. In which, the first feedback switch 131, the second feedback switch 132, the third feedback switch 133, and the fourth feedback switch 134 may be any kind of switch, such as relay or transistor.

Please refer to FIG. 5B. In the exemplary embodiment in FIG. 5B, the first feedback switch 131 and the third feedback switch 133 are respectively P-type MOSFETs S1 and S3, and the second feedback switch 132 and the fourth feedback switch 134 are respectively N-type MOSFETs S2 and S4.

As shown in FIG. 5B, the first feedback control end (gate of the MOSFET S1) of the first feedback switch 131 is connected to the negative output node OUTn, the second feedback control end of the second feedback switch 132 is connected to the positive output node OUTp, the third feedback control end of the third feedback switch 133 is connected to the positive output node OUTp, and the fourth feedback control end of the fourth feedback switch 134 is connected to the negative output node OUTn.

It is worth noting that the correct-direction connecting circuit 111 and the reverse-direction connecting circuit 113 are both in parallel connection with the voltage feedback unit 13. Therefore, when selecting the devices, the inner resistances of the first switch unit 1111, the second switch unit 1112, the third switch unit 1131, and the fourth switch unit 1132 must be extremely smaller than the inner resistances of the first feedback switch 131, the second feedback switch 132, the third feedback switch 133, and the fourth feedback switch 134. The device selection is for ensuring that most of the current flows through the correct-direction connecting circuit 111 or the reverse-direction connecting circuit 113, and just a small portion of the current flows through the voltage feedback unit 13, in order to reduce unexpected power consumption.

The inner resistance of the MOSFET can be obtained from the following formula which derived when the MOSFET is operating in tri-region: Rₒₙ=[μₙ*Cₒₓ*W/L*(V_{GS}−Vₜ−V_{DS})]⁻¹, wherein μₙ is the effective mobility of charge carriers, Cₒₓ is the capacitance of an oxide layer of the MOSFET, W/L is a width to length ratio, V_{GS} is the voltage difference between the gate and source of the MOSFET, V_{DS} is the voltage difference between the drain and source of the MOSFET, and Vₜ is the threshold voltage of the MOSFET. We can know from the formula that the inner resistance Rₒₙ of the MOSFET is reversely proportional to the width to length ration W/L. In a preferred selection of devices. MOSFETs Q1, Q2, Q3, and Q4 have greater width to length ratios than MOSFETs S1, S2, S3, and S4. According to the device selection, the inner resistances of the MOSFETs Q1, Q2, Q3 and Q4 may be smaller enough than the inner resistances of the MOSFETs S1, S2, S3, and S4, so as to ensure most of the current flows within the correct-direction connecting circuit 111 or the reverse-direction connecting circuit 113 rather than the voltage feedback unit 13.

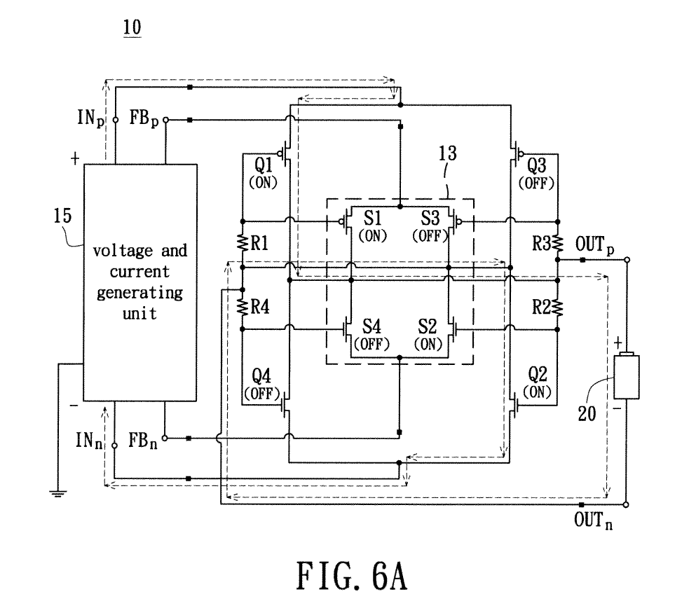

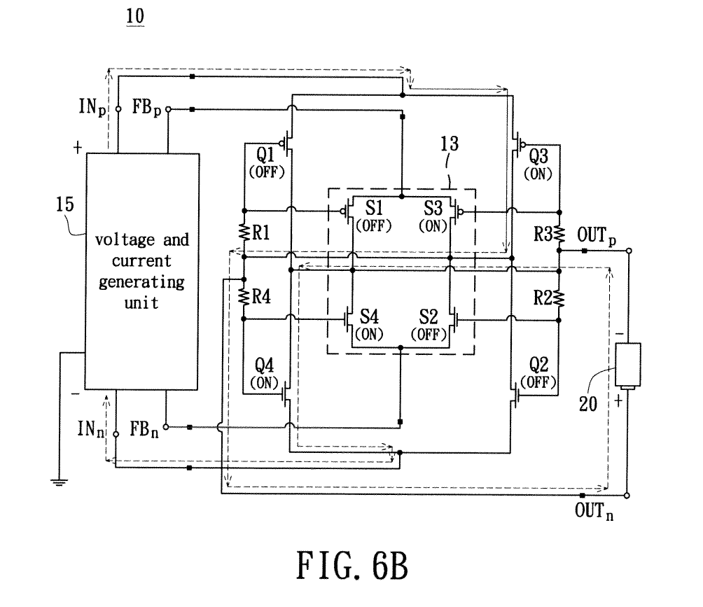

Please refer to FIG. 6A which is a schematic view of operation of the circuit in FIG. 5B. In this exemplary embodiment of the present disclosure, the connection polarity of the load 20 is correct, i.e., the positive end (high-voltage end) of the load 20 is connected to the positive output node OUTp while the negative end (low-voltage end) of the load 20 is connected to the negative output node OUTn. In this case, MOSFETs Q1, Q2, S1, and S2 are turned on, and the MOSFETs Q3, Q4, S3, and S4 are turned off.

At the moment, the current flows from the positive input node INp to the load 20 through the MOSFET Q1, and then from the negative end of the load 20 back to the negative input node INn through the MOSFET Q2. Furthermore, the voltage of the positive output node OUTp may feed back to the positive feedback end FBp because the MOSFET S1 is turned on, and the voltage of the negative output node OUTn may feed back to the negative feedback end FBn because the MOSFET S2 is turned on. As such, the voltage and current generating unit 15 may receive the load voltage.

It is worth noting that because the MOSFETs S1 and S2 are MOSFETs with smaller width to length ratio, the inner resistances are high, thus the current flowing through the MOSFETs S1 and S2 are very small. Therefore, unexpected power consumption cause by the MOSFET S1 and S2 may be extremely reduced, so that the load voltage fed back to the voltage and current generating unit 15 may be more precise.

After the voltage and current generating unit 15 receives the load voltage, the voltage difference of the input power received by the positive input node INp and the negative input node INn may be adjusted according to the load voltage for charging the load 20, in order to let the load voltage be charged to a predetermined voltage value precisely.

For example, a commercially available charger charges a battery at the constant current (CC) mode after the battery is inserted until the voltage of the battery reaches a predetermined value. After that, the charging mode is changed to constant voltage (CV) mode to continue the charging process until the battery is fully charged. If there is no voltage feedback unit 13 for feeding the load voltage back to the voltage and current generating unit 15, the charging voltage received by the load 20 may be affected due to the slightly voltage drop caused by some switch units in the charging circuits. Thus, the load 20 may not be accurately charged to the predetermined voltage value.

Therefore, the voltage and current generating unit 15 receives the fed-back load voltage, for resolving the mentioned problem that the load 20 may not be accurately charged to the predetermined voltage. By directly comparing the load voltage with a predetermined value, the charging mode may be changed from CC mode to CV mode when the load voltage actually reaches the predetermined value. The voltage difference of input power is adjusted at any time, so that the load 20 may be precisely charged to expected voltage level, thus increases the charging precision of the charger.

Please refer to FIG. 6B. FIG. 6B is a schematic view of operation of the circuit in FIG. 5B. According to this exemplary embodiment, the load 20 is connected reversely, i.e., the positive end (high-voltage end) is connected to the negative output node OUTn while the negative end (low-voltage end) is connected to the positive output node OUTp. At the moment, the MOSFETs Q3, Q4, S3, and S4 are closed, while MOSFETs Q1, Q2, S1, and S2 are opened.

The charging current is inputted from the positive input node INp and transmitted to the negative output node OUTn through the MOSFET Q3 for charging the load 20. Then the current goes back from the positive output node OUTp to the negative input node INn through the MOSFET Q4. The voltage of the positive output node OUTp is fed back to the negative end FBn through the MOSFET S4, and the voltage of the negative output node OUTn is fed back to the positive feedback end FBn through the MOSFET S3. Similarly, after the voltage and current generating unit 15 receives the feedback of the load voltage, the voltage and current of input power received by the input end INPUT may be adjusted accordingly. After that, the charging mode may be changed from CC mode to CV mode, so that the load 20 may be precisely charged to the expected voltage level accurately.

By turning the switch units on or off, the load may normally be charged no matter the load is plugged in the correct direction or in the reverse direction. Moreover, by the described voltage feedback control, the accuracy of charging may be increased and thus the safety and practical value in use of the charger may be further increased.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A polarity switch circuit for a charger, comprising:
a polarity switch unit, used to receive an input power for charging a load, wherein the polarity switch unit determines an output polarity of an output power provided to the load according to a connection polarity of the load connected to the polarity switch unit; and
an input control unit, electrically connected to the polarity switch unit for providing the input power to the polarity switch unit, wherein the input control unit retrieves a load voltage of the load, and adjusts voltage and current of the input power according to the load voltage.

2. The polarity switch circuit of claim 1, wherein the input control unit adjusts voltage and current of the input power according to the load voltage is that when the load voltage reaches a predetermined value, the input power is changed from a constant current mode to a constant voltage mode.

3. The polarity switch circuit of claim 1, wherein the polarity switch unit comprising:
an input end, comprising a positive input node and a negative input node for receiving the input power;
an output end, comprising a positive output node and a negative output node for outputting the output power to the load;
a correct-direction connecting circuit, electrically connected between the input end and output end, wherein when a voltage of the load connected at the positive output node is greater than a voltage of the load connected at the negative output node, the correct-direction connecting circuit electrically connects the positive input node to the positive output node and the negative input node to the negative output node; and
a reverse-direction connecting circuit, electrically connected between the input end and the output end, wherein when a voltage of the load connected at the positive output node is smaller than a voltage of the load connected at the negative output node, the reverse-direction connecting circuit electrically connects the positive input node to the negative output node and the negative input node to the positive output node.

4. The polarity switch circuit of claim 3, wherein:
the correct-direction connecting circuit comprising:
a first switch unit, electrically connected between the positive input node and the positive output node, wherein a first control end of the first switch unit is electrically connected to the negative output node; and
a second switch unit, electrically connected between the negative input node and the negative output node, wherein a second control end of the second switch unit is electrically connected to the positive output node;
the reverse-direction connecting circuit comprising:
a third switch unit, electrically connected between the positive input node and the negative output node, wherein a third control end of the third switch unit is connected to the positive output node; and
a fourth switch unit, electrically connected between the negative input node and the positive output node, wherein a fourth control end of the fourth switch unit is electrically connected to the negative output node;
wherein the first switch unit and the second switch unit are turned on when the voltage of the load connected at the positive output node is greater than the voltage of the load connected at the negative output node, and the third switch unit and the fourth switch unit are turned on when the voltage of the load connected at the negative output node is greater than the voltage of the load connected at the positive output node.

5. The polarity switch circuit of claim 4, wherein:
the correct-direction connecting circuit further comprising:
a first buffer resistor, connected between the first control end and the negative output node; and
a second buffer resistor, connected between the second control end and the positive output node;
the reverse-direction connecting circuit further comprising:
a third buffer resistor, connected between the third control end and the positive output node; and
a fourth buffer resistor, connected between the fourth control end and the negative output node.

6. The polarity switch circuit of claim 4, wherein the input control unit comprising:
a voltage feedback unit, electrically connected to the output end for feeding-back the load voltage of the load; and
a voltage and current generating unit, electrically connected to the voltage feedback unit and the input end, wherein the voltage and current generating unit comprises a positive feedback end and a negative feedback end for receiving the load voltage which is fed-back by the voltage feedback unit, and for controlling voltage and current of the input power received by the input end according to the load voltage.

7. The polarity switch circuit of claim 6, wherein the voltage feedback unit comprising:
a first feedback switch, electrically connected between the positive feedback end and the positive output node, wherein a first feedback control end of the first feedback switch is electrically connected to the negative output node;
a second feedback switch, electrically connected between the negative feedback end and the negative output node, wherein a second feedback control end of the second feedback switch is electrically connected to the positive output node;
a third feedback switch, electrically connected between the positive feedback end and the negative output node, wherein a third feedback control end of the third feedback switch is electrically connected to the positive output node; and
a fourth feedback switch, electrically connected between the negative feedback end and the positive output node, wherein a fourth feedback control end of the fourth feedback switch is electrically connected to the negative output node;
wherein the first feedback switch and the second feedback switch are turned on when the voltage of the load connected at the positive output node is greater than the voltage of the load connected at the negative output node, and the third feedback switch and the fourth feedback switch are turned on when the voltage of the load connected at the negative output node is greater than the voltage of the load connected at the positive output node.

8. The polarity switch circuit of claim 7, wherein the first switch unit, the third switch unit, the first feedback switch and the third feedback switch are P-type metal-oxide-semiconductor field-effect transistors (MOSFETs), and the second switch unit, the fourth switch unit, the second feedback switch and the fourth feedback switch are N-type MOSFETs.

9. The polarity switch circuit of claim 8, wherein width to length ratios of the first switch unit, the second switch unit, the third switch unit, and the fourth switch unit are greater than width to length ratios of the first feedback switch, the second feedback switch, the third feedback switch, and the fourth feedback switch.
